(19) United States
(12) Patent Application Publication
(10) Pub. No.: US 2010/0170057 A1
(43) Pub. Date: Jul. 8, 2010

(54) SLIM TYPE VACUUM INHALING APPARATUS HAVING HIGH EFFICIENCY AND ROBOT CLEANER USING THE SAME

(75) Inventors: Jong Hoon Lee, Incheon (KR); Nam Hun Lee, Suwon-si (KR); Byoung Kyu Kim, Seoul (KR)

Correspondence Address: CANTOR COLBURN, LLP, 20 Church Street, 22nd Floor, Hartford, CT, 06103, US

(73) Assignee: AMOTECH CO., LTD., Incheon (KR)

(21) Appl. No.: 12/602,378

(22) PCT Filed: May 7, 2008
(86) PCT No.: PCT/KR08/02553

§ 371 Date: Nov. 30, 2009

(30) Foreign Application Priority Data
May 31, 2007 (KR) 10-2007-0053367

(51) Int. Cl. A47L 5/00

(52) U.S. Cl. 15/319

(57) ABSTRACT

Provided is a high-efficiency slim vacuum inhalation apparatus which cools heat generated from heat-generation sources without using particular heat radiation components, and a robot cleaner employing the same. The vacuum inhalation apparatus does not need particular heat radiation components since an impeller is closely adhered to a rotational shaft by a pair of washers and an impeller bushing, to thus avoid from sliding, and since an inhalation efficiency which is caused by a brushless direct-current (BLDC) motor increases, and thus power consumption decreases. Further, since a BLDC motor is incorporated in a vacuum inhalation apparatus so that the vacuum inhalation apparatus can be implemented into a slim type, a robot cleaner can be also compactly realized into a slim type.

### TECHNICAL FIELD

This invention relates to a high efficiency slim type vacuum inhalation apparatus and a robot cleaner using the same, and more particularly, to high efficiency slim type vacuum inhalation apparatus and a robot cleaner using the same, which can cool heat that is generated from the vacuum inhalation apparatus for the robot cleaner without a special heat radiator, to thus manufacture the robot cleaner in a slim form, and improve productivity of the robot cleaner.

### BACKGROUND ART

Today, a number of electric home appliances are being developed and marketed. Among the number of electric home appliances, a vacuum cleaner is developed for cleanliness of a residence environment.

Vacuum cleaners are electric appliances which inhale air including foreign matters such as dust using a vacuum pressure generated by a BLDC motor that is installed in the inside of a main body of the vacuum cleaner, and filter the foreign matters in the inside of the main body.

Vacuum cleaners can be classified into a vacuum cleaner which is directly manipulated by a user and a robot cleaner that performs a cleaning work without user's manipulation. The robot cleaners move on a floor in a certain cleaning area according to an input program using an internal battery as an electric power source, and inhale air and then filter foreign matters from the inhaled air, to thus perform a cleaning work.

The robot cleaner, in particular, a wireless type robot cleaner using an internal battery as an electric power source, need to employ a low electric power consumption and high efficiency BLDC motor in a vacuum inhalation apparatus in order to generate a vacuum pressure in the robot cleaner.

The BLDC motor needs a driver including an electric power drive element, and requires for a heat radiation countermeasure for quickly heat radiating heat generated from the electric power drive element, in order to produce high power of 100 W or more. As described above, in order to radiate heat generated from a robot cleaner, separate heat radiating fins should be provided or the BLDC motor should be surrounded, or a housing in which the BLDC motor is mounted should be formed of metal of a high heat conductivity such as aluminium.

Therefore, since a conventional vacuum inhalation apparatus performs a heat radiation operation with a structure that an electric power drive element of the BLDC motor is attached to a radiating fin or a radiating housing, it is difficult to employ a slim type structure that the BLDC motor is closely attached to a fan guide of the vacuum inhalation apparatus. That is, it was not possible to design the vacuum inhalation apparatus into an internal type that makes the drive motor located in a space between the fan guide and the control PCB.

In addition, in the case that a heat radiating structure such as a heat radiating fin or a heat radiating housing is provided in order to cool heat generated from the BLDC motor, the heat radiating structure should be mounted in the inside of the vacuum inhalation apparatus of he robot cleaner. Accordingly, the internal structure of the robot cleaner becomes complicated. Further, size of the vacuum inhalation apparatus becomes large due to the space in which the heat radiating structure is mounted. In addition, in the case that the housing of the BLDC motor is formed of the heat radiating structure, weight of the vacuum inhalation apparatus (that is, the robot cleaner) becomes increased. As a result, an electric power consumption is caused to increase. Moreover, if weight and size of the robot cleaner increase, it becomes an obstacle factor when designing the housing of the robot cleaner in a slim type to clean a portion under a sofa or bed.

Meanwhile, the robot cleaner basically occupies a very large space to accommodate a secondary electric cell module for a power supply into the inside of the robot cleaner, a pair of drive motors for independently driving a pair of wheels, and a dust collector. Accordingly, a space for the vacuum inhalation apparatus to be disposed is not large. Further, a filter is arranged on the lateral side of the front and rear ends of the vacuum inhalation apparatus, respectively.

Specially, because the overall length of the conventional vacuum inhalation apparatus is longer than the height of an arrangement space of the slim type robot cleaner, the vacuum inhalation apparatus should employ an installation structure of being inclined or horizontally disposed when the vacuum inhalation apparatus is built in the housing of the robot cleaner.

As a result, since the conventional vacuum inhalation apparatus has been horizontally disposed or slantingly arranged, it becomes an obstacle factor when designing the housing of the robot cleaner in a slim type or compact form.

Therefore, it is required to make size of the robot cleaner compact and reduce weight of the robot cleaner by cooling heat that is produced in the BLDC motor of the robot cleaner without using particular heat radiation elements.

Further, the robot cleaner need to maximize an inhalation force and an inhalation efficiency of inhaling air to clean a wide area with high cleanness and short time basically. Therefore, in order to maximize a cleaning efficiency of the robot cleaner, the power and rotational force of a motor for a vacuum inhalation apparatus which inhales air should be maximized. However, the power and rotational force of the motor which is applied to the conventional vacuum inhalation apparatus does not reach a required level and further an electric power consumption becomes large.

Meanwhile, according to the conventional art, the central portion of the impeller has a structure of compressively being supported to a rotor bushing by an impeller bushing whose diameter is small. By this structure, the rotational force of the rotor is transferred via the central portion of the impeller. As a result, there is a problem that the rotational force of the rotor is not effectively delivered to the impeller because the impeller slides from the rotational shaft during rotation of the rotor.

Further, positions of a pair of bearings that support the rotational shaft of the BLDC motor should be exactly set. To do this, the positions of the bearings require for being set in a tolerance range of 1/100 or less. In this case, an expensive precise mold should be used. However, without using the expensive precise mold, a designing method of obtaining a concentricity of the bearings without using the expensive precise mold is required.

### DISCLOSURE

### Technical Problem

To solve the above problems, it is an object of the present invention to provide a high efficiency slim type vacuum inhalation apparatus and a robot cleaner using the same, in which a passage route of external air which is inhaled under the vacuum condition is designed to have a curved passage route which is short as well as has a small frictional resistance, to thereby increase an inhalation efficiency and reduce an electric power consumption, and accordingly cool heat that is generated in an electric power drive element without using a special heat radiator (for example, a heat radiation fin).

It is another object of the present invention to provide a high efficiency slim type vacuum inhalation apparatus and a robot cleaner using the same, in which a high efficiency BLDC motor is employed to thus reduce an electric power consumption, and to resultantly cool heat that is produced in an electric power drive element without using a special heat radiator (for example, a heat radiation fin).

It is still another object of the present invention to provide a high efficiency slim type vacuum inhalation apparatus and a robot cleaner using the same, in which it is possible to design a drive motor into an internal built-in type where the drive motor is located in a space between a fan guide and a control PCB to thus minimize length of the vacuum inhalation apparatus, and to thereby incorporate the vacuum inhalation apparatus into a robot cleaner in a vertical type and make the whole structure of the robot cleaner in a slim form.

It is yet another object of the present invention to provide a high efficiency slim type vacuum inhalation apparatus and a robot cleaner using the same, in which when an impeller of the vacuum inhalation apparatus is rotated by rotation of the motor, the rotational force of the motor is effectively transferred to the impeller, to accordingly make the impeller rotate without slipping.

It is yet still another object of the present invention to provide a high efficiency slim type vacuum inhalation apparatus and a robot cleaner using the same, in which a drive motor is separately assembled in and combined with a vacuum inhalation apparatus, to thereby enhance an assembly performance of assembling the drive motor into the vacuum inhalation apparatus.

### Technical Solution

To accomplish the above object of the present invention, according to an aspect of the present invention, there is provided a vacuum inhalation apparatus comprising:

a brushless direct-current (BLDC) motor comprising a rotor and a stator, for generating a rotational force;

a rotational shaft which is fixedly combined at the center of the rotor through a rotor bushing so as to rotate;

an impeller which is located on the upper portion of the rotor and whose lower plate is fixedly coupled at one side of the rotational shaft to thus generate an inhalation force via a first intake hole which is located at the center of the upper plate of the impeller when the rotational shaft rotates;

a fan guide which is disposed between the impeller and the BLDC motor, in which a number of spiral guide grooves which guide a flow of air which is inhaled by the inhalation force generated by the impeller are formed in the outer circumferential portion of the fan guide and a number of fan connecting rods are extended in the outer circumferential portion of the lower end of the fan guide so as to surround the BLDC motor;

a control printed circuit board (PCB) in which the stator is fixed, and which applies a drive voltage for the BLDC motor;

a PCB cover that fixedly supports the number of the fan connecting rods of the fan guide, and protects the lower portion of the control PCB; and

a cover in which a second inhalation hole which is located at the center of the cover is extended to the first inhalation hole of the impeller, and the outer circumferential portion of the cover surrounds the impeller and the fan guide, and which is extended to form an air passage route between the number of guide grooves and the inner circumferential portion of the cover and is combined in the outer circumferential portion of the fan guide.

According to another aspect of the present invention, there is also provided a vacuum inhalation apparatus comprising:

a brushless direct-current (BLDC) motor comprising a rotor and a stator, for generating a rotational force;

a rotational shaft which is fixedly combined at the center of the rotor through a rotor bushing so as to rotate;

a control printed circuit board (PCB) to the bottom of which the stator is fixed, and which applies a drive voltage for the BLDC motor;

an impeller whose lower plate is fixedly coupled at one side of the rotational shaft to thus generate an inhalation force via a first intake hole which is located at the center of the upper plate of the impeller when the rotational shaft rotates;

a fan guide which is disposed between the impeller and the control PCB, in which a number of spiral guide grooves which guide a flow of air which is inhaled by the inhalation force generated by the impeller toward the upper side of the control PCB are formed in the outer circumferential portion of the fan guide and a number of fan connecting rods which are located at the outer circumferential portion of the lower end of the fan guide are fixedly supported to the outer circumferential portion of the control PCB; and

a cover in which a second inhalation hole which is located at the center of the cover is extended to the first inhalation hole of the impeller, and the outer circumferential portion of the cover surrounds the impeller and the fan guide, and which is extended to form an air passage route between the number of guide grooves and the inner circumferential portion of the cover and is combined in the outer circumferential portion of the fan guide.

Preferably but not necessarily, according to the one aspect of the present invention, the vacuum inhalation apparatus further comprises:

a lower impeller washer which contacts between the rotor bushing and the lower-center portion of a lower plate of the impeller over a wide contact area;

an upper impeller washer whose lower surface contacts the upper-center portion of the lower plate of the impeller over a wide contact area;

an impeller bushing which is located at the upper portion of the upper impeller washer and has a relatively smaller contact area than that of the upper impeller washer, and with a hole at the center of which the rotational shaft is combined; and

a fixing nut which is screw-combined with the upper portion of the rotational shaft and makes the impeller bushing and the upper and lower impeller washers closely adhered to the rotor bushing, to thus make the impeller fixed to the rotational shaft.

Preferably but not necessarily, according to the one aspect of the present invention, the vacuum inhalation apparatus further comprises:

a first bearing that is placed in the bushing formed in the inner circumferential portion of the stator and that rotatably supports one end of the rotational shaft; and

a second bearing which is placed at the central portion of the cover, to thus rotatably supports the other end of the rotational shaft,

wherein a number of protrusions are formed in bearing accommodation grooves where the first and second bearings of the bushing and the central portion of the cover are installed.

Preferably but not necessarily, according to the one aspect of the present invention, the stator comprises:

a number of division type cores;

a number of bobbins which are formed of an insulation material and are combined with the outer circumference of the division type cores, respectively;

a coil that is wound in a space that is provided by the bobbins; and

a stator holder including a hook and a first bearing accommodation groove which are combined on the control PCB and which is integrated by an insert molding method using thermosetting resin to form a number of division type core assemblies where the coil is wound around the bobbins of the division type core in an annular form,

wherein a number of protrusions are formed in the inner circumferential surface of the first bearing accommodation groove, in order to minimize a tolerance of the built-in first bearing.

Preferably but not necessarily, according to the one aspect of the present invention, the BLDC motor comprises:

a rotor where a number of N-pole and S-pole magnets are alternately arranged in the inner circumferential surface of a yoke frame which is bent and extended from a central frame;

a stator which is arranged in the inside of the rotor and around which the coil is individually wound at a state where the bobbins are combined with the number of division type cores, respectively, to thereby be integrally formed via the stator holder by an insert molding method using thermosetting resin;

a rotational shaft which is combined in the central portion of the rotor through the rotor bushing so as to rotate; and

a control printed circuit board (PCB) which is hook-combined via a hook which is integrally formed with the stator holder, to thereby fix the stator and to thereby apply a drive voltage for the BLDC motor.

Preferably but not necessarily, according to the one aspect of the present invention, the vacuum inhalation apparatus is applied in a robot cleaner.

Preferably but not necessarily, according to the other aspect of the present invention, the vacuum inhalation apparatus further comprises:

a lower impeller bushing which is located at the upper portion of the first bearing and with a hole at the center of which the rotational shaft is combined;

a lower impeller washer which has a relatively larger contact area than that of the lower impeller bushing, and contacts the lower-center portion of the lower plate of the impeller;

an upper impeller washer whose lower surface contacts the upper-center portion of the lower plate of the impeller over a wide contact area;

an upper impeller bushing which has a relatively smaller contact area than that of the upper impeller washer, and with a hole at the center of which the rotational shaft is combined; and

a fixing nut which is screw-combined with the upper portion of the rotational shaft and makes the upper and lower impeller bushings and the upper and lower impeller washers closely adhered to the first bearing, to thus make the impeller fixed to the rotational shaft.

According to an embodiment of the robot cleaner of the present invention, there is provided a robot cleaner comprising:

a main body;

a number of wheels which are located at the lower portion of the main body, and which make the main body move to a predetermined direction;

a dust collector which collects foreign matters in air inhaled via an inhalation nozzle;

a vacuum inhalation apparatus which generates an inhalation force that inhales air through the inhalation nozzle; and

a battery that offers a drive power to the vacuum inhalation apparatus,

wherein the vacuum inhalation apparatus comprises:

a brushless direct-current (BLDC) motor comprising a rotor and a stator, for generating a rotational force;

a rotational shaft which is fixedly combined at the center of the rotor through a rotor bushing so as to rotate;

an impeller which is located on the upper portion of the rotor and whose lower plate is fixedly coupled at one side of the rotational shaft to thus generate an inhalation force via a first intake hole which is located at the center of the upper plate of the impeller when the rotational shaft rotates;

a fan guide which is disposed between the impeller and the BLDC motor, in which a number of spiral guide grooves which guide a flow of air which is inhaled by the inhalation force generated by the impeller are formed in the outer circumferential portion of the fan guide and a number of fan connecting rods are extended in the outer circumferential portion of the lower end of the fan guide so as to surround the BLDC motor;

a control printed circuit board (PCB) in which the stator is fixed, and which applies a drive voltage for the BLDC motor;

a PCB cover that fixedly supports free ends of the number of the fan connecting rods of the fan guide, and protects the lower portion of the control PCB; and

a cover in which a second inhalation hole which is located at the center of the cover is extended to the first inhalation hole of the impeller, and the outer circumferential portion of the cover surrounds the impeller and the fan guide, and which is extended to form an air passage route between the number of guide grooves and the inner circumferential portion of the cover and is combined in the outer circumferential portion of the fan guide.

Preferably but not necessarily, according to the one embodiment of the present invention, the stator comprises a stator holder which is integrally formed by assembling a number of division type cores around which the coil is individually wound in an annular form, using thermosetting resin.

Preferably but not necessarily, according to the other aspect of the present invention, the robot cleaner further comprises:

a lower impeller washer which contacts between the rotor bushing and the lower-center portion of a lower plate of the impeller over a wide contact area;

an upper impeller washer whose lower surface contacts the upper-center portion of the lower plate of the impeller over a wide contact area;

an impeller bushing which is located at the upper portion of the upper impeller washer and has a relatively smaller contact area than that of the upper impeller washer, and with a hole at the center of which the rotational shaft is combined;

a fixing nut which is screw-combined with the upper portion of the rotational shaft and makes the impeller bushing and the upper and lower impeller washers closely adhered to the rotor bushing, to thus make the impeller fixed to the rotational shaft.

Preferably but not necessarily, according to the other aspect of the present invention, the robot cleaner further comprises:

a first bearing that is placed in the bushing formed in the inner circumferential portion of the stator and that rotatably supports one end of the rotational shaft; and

a second bearing which is placed at the central portion of the cover, to thus rotatably supports the other end of the rotational shaft,

wherein a number of protrusions are formed in bearing accommodation grooves where the first and second bearings of the bushing and the central portion of the cover are installed.

### Advantageous Effects

As described above, in the case of a vacuum inhalation apparatus according to the present invention, the rotational force of a rotor is effectively transferred to an impeller to thus pass through a curved passage route whose path is short and frictional resistance is small. Accordingly, accelerated airflow cools the inside of a motor. As a result, an inhalation efficiency increases more greatly than that of the conventional art, and an electric power consumption becomes small. Thus, an amount of heat generated from a power drive element decreases, and thus the inside of the motor can be cooled without having a special heat radiator.

In addition, the vacuum inhalation apparatus according to the present invention need not employ an aluminium heat radiator whose volume is large in order to cool conventional power drive elements. Accordingly, it is possible to design a drive motor as an internal type where the drive motor is located in an internal space between a fan guide and a control PCB. Thus, the whole length of the drive motor can be implemented in small size. As a result, the drive motor can be disposed in a vertical style in a cleaner, to thereby make the cleaner in a slim and compact style.

Further, when an impeller of the vacuum inhalation apparatus is rotated by rotation of the motor, the rotational force of the motor is effectively transferred to the impeller. Accordingly, the impeller can rotate without slipping. As a result, an assembly performance of assembling a motor into a vacuum inhalation apparatus can be improved.

In addition, when manufacturing a vacuum inhalation apparatus of a robot cleaner, for example, when producing a stator of a motor or a PCB cover by an injection molding, a molding condition is mitigated to thus improve productivity.

### DESCRIPTION OF DRAWINGS

The above and other objects and advantages of the present invention will become more apparent by describing the preferred embodiments thereof in detail with reference to the accompanying drawings in which:

FIG. 1 is a perspective view to explain an external form of a robot cleaner according to this invention;

FIG. 2 is a perspective view to schematically explain the internal components of a robot cleaner according to the present invention;

FIG. 3 is a perspective view to schematically explain a robot cleaner according to the present invention, viewed from the bottom of the robot cleaner;

FIGS. 4A to 4C are a perspective view, a cross-sectional view, and a disassembled perspective view for explaining an vacuum inhalation apparatus for a robot cleaner according to a preferred embodiment of the present invention, respectively;

FIG. 5 is a cross-sectional view to explain a BLDC motor for a vacuum inhalation apparatus according to a first preferred embodiment of this invention;

FIGS. 6A and 6B are a cross-sectional view to explain an integral type core and an integral type core assembly according to an embodiment of the present invention, respectively;

FIGS. 7A and 7B are a cross-sectional view to explain a division type core and a division type core assembly according to an embodiment of the present invention, respectively;

FIG. 8 is a cross-sectional view to explain structure of a bearing housing according to this invention;

FIG. 9 is a cross-sectional view to explain a rotor for a BLDC motor according to this invention; and

FIG. 10 is a partially cut cross-sectional view to explain a vacuum inhalation apparatus for a robot cleaner according to a second embodiment of this invention.

### BEST MODE

Hereinbelow, a vacuum inhalation apparatus and a robot cleaner using the same according to the present invention will be described with reference to the accompanying drawings. Like reference numerals denote like elements through the following embodiments. However, the detailed description of the relevant know functions or structures will be omitted when operational principles of the preferred embodiments of the present invention are described.

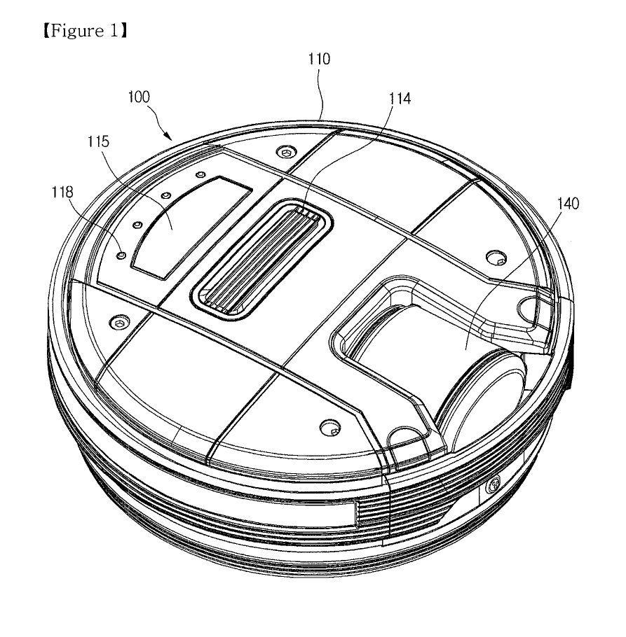

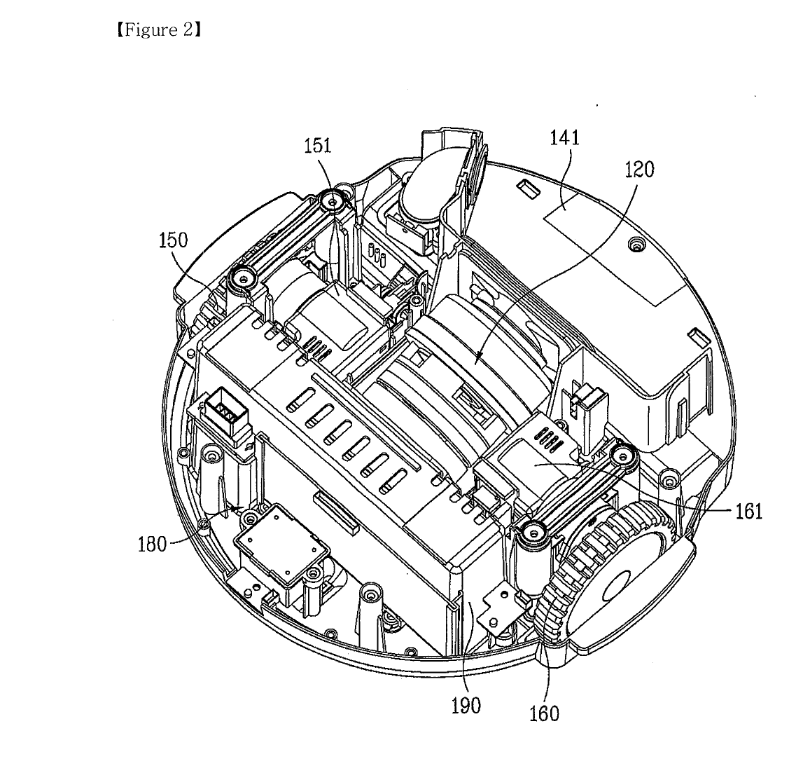

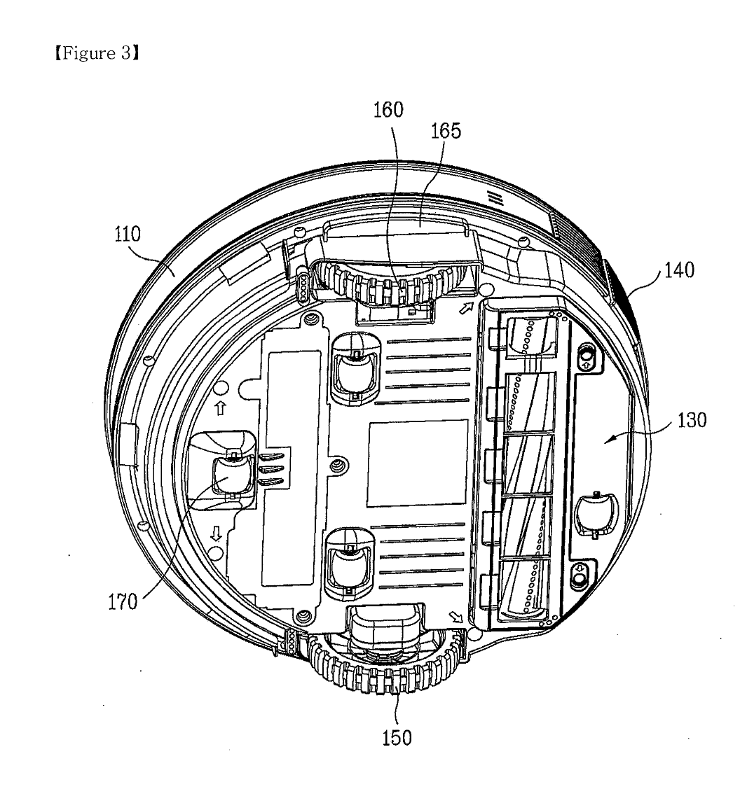

FIG. 1 is a perspective view to explain an external form of a robot cleaner according to this invention. FIG. 2 is a perspective view to schematically explain the internal components of the robot cleaner shown in FIG. 1. FIG. 3 is a perspective view to schematically explain the robot cleaner shown in FIG. 1, viewed from the bottom of the robot cleaner.

Referring to FIGS. 1 to 3, a robot cleaner 100 includes a main body 110 that forms external appearance, a vacuum inhalation apparatus 120 which is provided in the inside of the main body 110, to change the internal air pressure into a vacuum pressure, and generates an inhalation force for inhaling external air including foreign matters, and an inhalation nozzle 130 that inhales air by drive of the vacuum inhalation apparatus 120, and a dust collector 140 that collects the foreign matters in the air inhaled from the inhalation nozzle 130.

As illustrated, the main body 110 may be formed as a flat cylindrical shape. A sensor (not shown) that senses distance from an indoor wall or an obstacle and a bumper (not shown) which absorbs impact when colliding, may be provided in the outer circumference surface of the main body 110.

In addition, a manipulation button 118 with which operation of the robot cleaner 100 can be manipulated, and a displays portion 115 which displays the operational states of the robot cleaner 100, are formed in the upper side of the main body 110. An exhaust cover 114 that covers an exhaust filter (not shown) through which the inhaled air is exhausted is provided at the central portion of the main body 100.

Meanwhile, a controller 180 which controls drive of the robot cleaner 100 and a battery 190 that supplies electric power to the robot cleaner 100 are mounted in the inside of the main body 110. The vacuum inhalation apparatus 120 which generates inhalation force is placed at the back of the battery 190. A dust collector mount portion 141 in which the dust collector 140 is mounted is located at the back of the vacuum inhalation apparatus 120.

In addition, the dust collector 140 is mounted attachably/detachably into the dust collector mount portion 141 located at the back of the main body 110. Left and right wheels 150 and 160 are respectively provided in both sides of the lower portion of the main body 110, so that the robot cleaner 100 can move. A left wheel motor 151 and a right wheel motor 161 which operate by the controller 180 are connected with the respective wheels 150 and 160 so that the robot cleaner 100 can move.

Therefore, the robot cleaner 100 moves according to drive of the left wheel motor 151 and the right wheel motor 161, to thus perform a cleaning work in a predetermined cleaning area.

In addition, grip portions 165 are provided in both sides of the respective wheels 150 and 160, so that a user easily grips the robot cleaner 100. At least one auxiliary wheel 170 is provided in the lower surface of the main body 110. Accordingly, a friction between the robot cleaner 100 and a floor is minimized and simultaneously the robot cleaner 100 smoothly moves.

In the case of the robot cleaner 100 as constructed above, if a user presses a manipulation button 118, and thus selects a cleaning mode of the robot cleaner 100, the controller 180 controls the robot cleaner 100 according to a stored program. That is, the controller 180 drives the vacuum inhalation apparatus 120 so that air can be inhaled through the inhalation nozzle 130, and foreign matters can be collected in the dust collector 140. In addition, the controller 180 drives the left/right wheel motors 151 and 161, and makes the robot cleaner 100 move along a predetermined route to perform a cleaning work.

In the case of the robot cleaner 100 that is illustrated in FIGS. 1 to 3, the vacuum inhalation apparatus 120 is designed in an inclined arrangement structure like the conventional art. In the case that the vacuum inhalation apparatus according to the present invention which will be described below is employed, the vacuum inhalation apparatus can be implemented into a slim structure, and thus it is possible to dispose the vacuum inhalation apparatus 120 in the vertical direction. As a result, filters which are disposed at tan inlet and an outlet of the vacuum inhalation apparatus 120 can be disposed in a space which occurs according to slimming of the drive motor. Accordingly, the whole robot cleaner can be manufactured in a slim type.

The robot cleaner 100 can be manufactured in compact size, according to slimming and minimization of size of the vacuum inhalation apparatus 120.

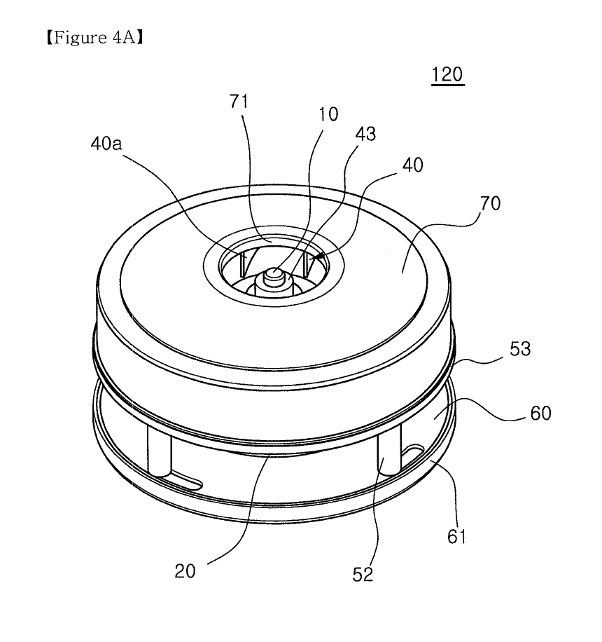

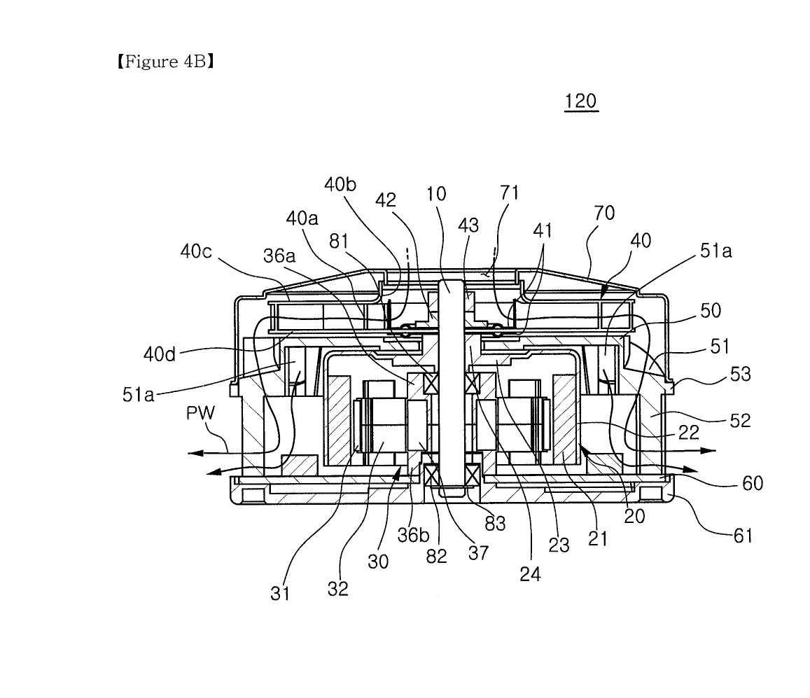

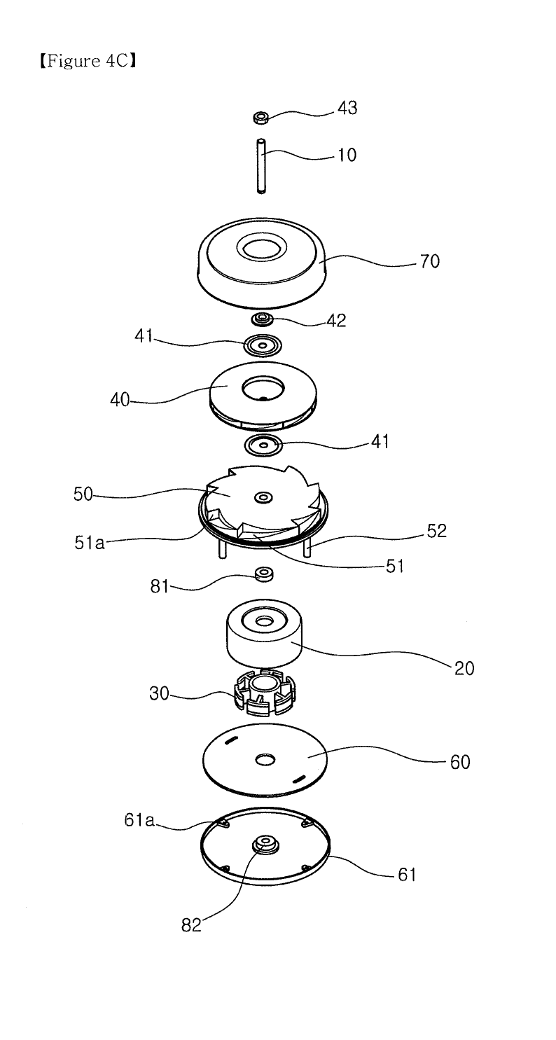

FIGS. 4A to 4C are a perspective view, a cross-sectional view, and a disassembled perspective view for explaining an vacuum inhalation apparatus for a robot cleaner according to a preferred embodiment of the present invention, respectively.

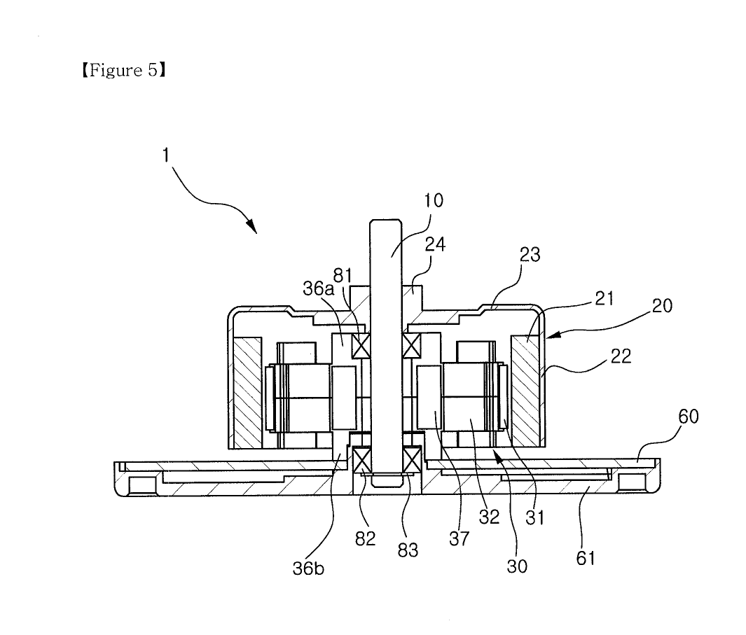

Referring to FIGS. 4A to 4C, the vacuum inhalation apparatus 120 in the robot cleaner according to this invention, is coupled with a control printed circuit board (PCB) 60 where control circuit elements that apply a driving current to a stator of the motor in a PCB cover 61 are installed. The stator 30 of a BLDC motor 1 (FIG. 5) is combined with one side of the control PCB 60, for example, the upper side of the control PCB 60.

In addition, the stator 30 and the rotor 20 are position-set so that a gap between the outer circumference surface of the stator 30 and the inner circumference surface of the rotor 20 can be maintained to then be combined on the control PCB 60, and the rotational shaft 10 is combined at the central portion of a central frame 23 of the rotor 20.

The control PCB 60 fixedly supports the stator 30 to be assembled, and applies a voltage charged in the battery 190 as a drive voltage to the BLDC motor 1. Therefore, the robot cleaner 100 according to this invention corresponds to a wireless type cleaner.

Here, the rotational shaft 10 is inserted into the central frame 23 of the rotor 20, and the central frame 23 and the rotational shaft 10 are fixed by a rotor bushing 24, and thus the rotational shaft 10 rotates according to rotation of the rotor 20.

Moreover, a fan guide 50 is located in the upper portion of the rotor bushing 24, and includes a number of guide grooves 51 that guide inhaled air. The fan guide 50 is fixedly supported by a number of fan connecting rods 52, for example, four fan connecting rods 52. The respective fan connecting rods 52 are fixedly combined with coupling holes 61a that are provided in the PCB cover 61. That is, the four fan connecting rods 52 are fixed to the PCB cover 61, and thus the fan guide 50 is fixed.

The guide grooves 51 of the fan guide 50 spirally proceed along the circumferential direction on the outer circumferential portion of the fan guide 50 opposing the cover 70, respectively. Accordingly, widths of the guide grooves 51 widen gradually, and the guide grooves 51 are extended from the upper side thereof to the lower side thereof. That is, the guide grooves 51 are formed in a spiral structure. The air that passes the guide grooves 51 moves to the inside of the motor 1 through an inhalation hole 51a, cools the rotor 20 and the stator 30 which constitute the motor 1 and circuitry elements of a drive transistor, etc., which is surface-mounted on the upper surface of the control PCB 60 by an air cooling method, and then, is discharged through a space between the fan connecting rods 52.

An impeller 40 arranged in the upper portion of the fan guide 50 includes: an annular upper plate 40c from the upper side of which a circular inlet 40b is protruded; a circular lower plate 40d which is disposed in parallel with and with a certain gap from the annular upper plate 40c; and a number of guide vanes 40a that are arranged in a spiral partition form between the upper plate 40c and the lower plate 40d and form an air flow path that guides air that has been inhaled via the inlet 40b to the circumferential portion.

The impeller 40 is fixedly combined with the rotational shaft 10 at the central portion of the lower plate 40d of the impeller 40 for coupling (that is, power transmission) with the rotor 20. That is, the rotational shaft 10 is fixedly combined with the central portion of the lower plate 40d of the impeller 40, the central portion of a pair of impeller washers 41 and an impeller bushing 42. Moreover, a stop nut 43 is screw-engaged in the upper portion of the impeller bushing 42 in order to prevent the impeller bushing 42 and the pair of the impeller washers 41 from seceding and to further strengthen a coherence between the rotational shaft 10, and the impeller 40 and the rotor 20.

Therefore, according to tightening of the stop nut 43, the impeller bushing 42 compressively supports a pair of impeller washers 41 whose contact area is large at the central portion of the lower plate 40d of the impeller 40. Accordingly, the impeller 40 is closely adhered with the rotor bushing 24. As a result, the impeller 40 is rotated without sliding at the time of rotation of the rotor 20 and the rotational force of rotor 20 is effectively delivered to the impeller 40.

In addition, a cover 70 which protects the inner composition of the vacuum inhalation apparatus 120 and forms external appearance is combined in the upper portion of the impeller 40. The lower portion of the cover 70 is situated at a coupling protrusion 53 which is provided on the outer circumference of the fan guide 50, to then be fixed. A circular inlet 71 through which air flows in is formed at the central portion of the cover 70. The inner circumferential portion of the circular inlet 71 is extensively formed into the inlet 40b of the impeller 40 to thus guide the inhaled external air to the inlet 40b of the impeller 40. The cylindrical lower portion which maintains a certain gap with respect to the outer circumferential portion of the impeller 40 forms an outer wall of a passage route (PW) which guides introduced air which is discharged from the impeller 40 into the guide grooves 51 of the fan guide 50.

Meanwhile, the rotational shaft 10 is rotatably supported by first and second bearings 81 and 82 which are installed at first and second positions between a predetermined gap is maintained.

The first bearing 81 is inserted into and incorporated in a bearing accommodation groove formed in a bushing 36a arranged in the inner portion of the stator 30, and the second bearing 82 is inserted into and incorporated in a bearing accommodation groove formed in the PCB cover 61. The bushing 36a may be formed together when the stator 30 is formed by an insert molding method. In addition, a snap ring 83 is combined at the lower portion of the rotational shaft 10 in a snap form in order to prevent the second bearing 82 from seceding.

In the case of the vacuum inhalation apparatus 120 for the robot cleaner as constructed above, if a drive voltage is applied to the BLDC motor 1 and thus the impeller 40 is rotated at high speed according to rotation of the rotor 20, the air existing in the inside of the impeller 40 is discharged to the lower side, that is, the inside of the motor 1 along the guide grooves 51 of the fan guide 50 by action of a number of guide vanes 40a which are spirally arranged in the inside of the impeller 40, to thus generate a strong negative pressure.

If the strong negative pressure occurs, the external air is inhaled through the inlet 71 of the cover 70, and thus moves along the guide grooves 51 of the fan guide 50 through the impeller 40. Then, the air that is inhaled into the motor 1 is discharged through a discharge space between the fan connecting rods 52 of the fan guide 50, to thereby generate an air flow.

Here, foreign matters included in the inhaled air are collected in a dust collector 140 by a strong vacuum inhalation force which is generated in the vacuum inhalation apparatus 120. Then, the air from which the foreign matters have been removed is discharged to the outside through an exhaust cover 114.

As described above, the vacuum inhalation apparatus 120 according to the present invention makes the shortest passage route (PW) curved when the external air is discharged along the minimized distance passing through the inlet 71 of the cover 70, the impeller 40, the guide grooves 51 of the fan guide 50, the inside of the motor 1, and the discharge space formed between the fan connecting rods 52, according to rotation of the impeller 40, and thus is set to have a natural airflow path to thereby minimize a frictional resistance element.

In addition, a number of the guide grooves 51 of the fan guide 50 spirally proceed along the circumferential direction on the outer circumferential portion of the fan guide 50 opposing the cover 70, respectively, to accordingly form the passage route (PW) whose width and depth are gradually widened. As a result, if the impeller 40 rotates at high speed, and thus high pressure air is supplied to the guide grooves 51, the guide grooves 51 and the inhalation hole 51a act like a spray nozzle, to thereby accelerate an airflow.

Thereafter, the accelerated airflow that has passed through the guide grooves 51 has a path along which the air moves to the inside of the motor 1, cools the rotor 20 and the stator 30 and circuitry elements of a drive transistor, etc., which is surface-mounted on the upper surface of the control PCB 60 by an air cooling method, and is discharged through a space formed between the fan connecting rods 52.

Moreover, in the case of the vacuum inhalation apparatus 120 according to the present invention, the rotational force of the rotor 20 is effectively transferred to the impeller 40 to thus pass through a passage route (PW) whose path is short and frictional resistance is small. Accordingly, accelerated airflow cools the inside of the motor 1. As a result, an inhalation efficiency increases more greatly than that of the conventional art, and an electric power consumption becomes small. Thus, an amount of heat generated from a power drive element decreases, and thus the inside of the motor can be cooled without having a special heat radiator (for example, aluminium heat radiation fins).

Thus, the vacuum inhalation apparatus 120 according to the present invention need not employ an aluminium heat radiator whose volume is large in order to cool conventional power drive elements. Accordingly, it is possible to design the BLDC motor 1 as an internal type where the BLDC motor 1 is located in an internal space between the fan guide 50 and the control PCB 60.

As a result, in comparison with the structure of the conventional art where the BLDC motor is designed as an external type, the length of the vacuum inhalation apparatus 120 can be manufactured in a slim type by the reduced height (that is, length) of the whole length of the BLDC motor 1, that is, about 40%. Accordingly, the BLDC motor 1 can be disposed in a vertical style in the robot cleaner 100, to thereby make the whole size of the cleaner in a slim and compact style.

FIG. 5 is a cross-sectional view to explain a BLDC motor for a vacuum inhalation apparatus according to a first preferred embodiment of this invention.

Referring to FIG. 5, the rotor 20 of the BLDC motor 1 is fixedly supported when the rotational shaft 10 is inserted into a throughhole of the rotor bushing 24 that is provided at the central portion of the central frame 23.

In addition, a number of magnets, for example, four magnets (two N-pole magnets and two S-pole magnets) 21 are fixed and adhered on the inner circumference of a cylindrical yoke frame 22 that is bent and extended at right angle from the central frame 23, and each magnet 21 is adhered to face each other in the direction of the stator 30.

Meanwhile, a stator holder of the stator 30, that is, bushings 36a and 36b are formed by insert-molding, so as to accomplish an annular shape using a BMC (bulk molding compound) after the coil 35 is wound at a state where the bobbins 32 are combined with the cores whose cross-sections are substantially ‘T’-shaped, respectively. Here, at the time of insert-molding the stator 30, a bearing accommodation groove is formed at an area corresponding to a first position of the first bushing 36a.

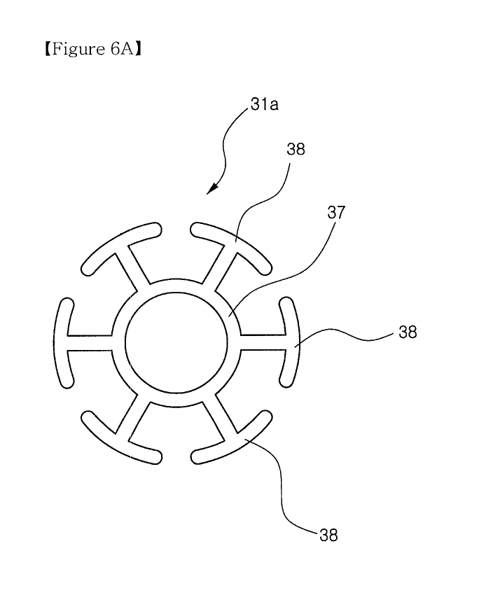

FIGS. 6A and 6B are a cross-sectional view to explain an integral type core and an integral type core assembly according to an embodiment of the present invention, respectively.

Referring to FIGS. 6A and 6B, the integral type cores 31a according to the present invention includes a cylindrical portion 37 formed of an annular shape in whole, and six slots where for example six ‘T’ or ‘I’ type teeth are radially extended from the annular cylindrical portion 37. If bobbins 32a of an insulation material are formed by an insert molding method in the outer circumferential portion of the teeth 38. If a coil 35 is wound around the outer circumference of the bobbins, an integral type core assembly 33a is obtained.

Thereafter, the integral type core assembly 33a is molded by an insert molding method so that the bushing 36a is provided to thus form the stator 30.

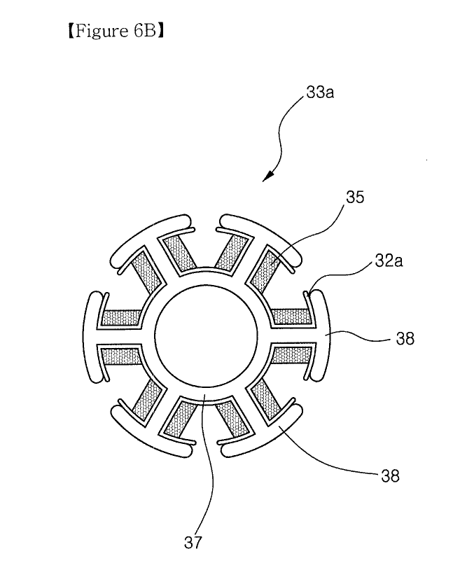

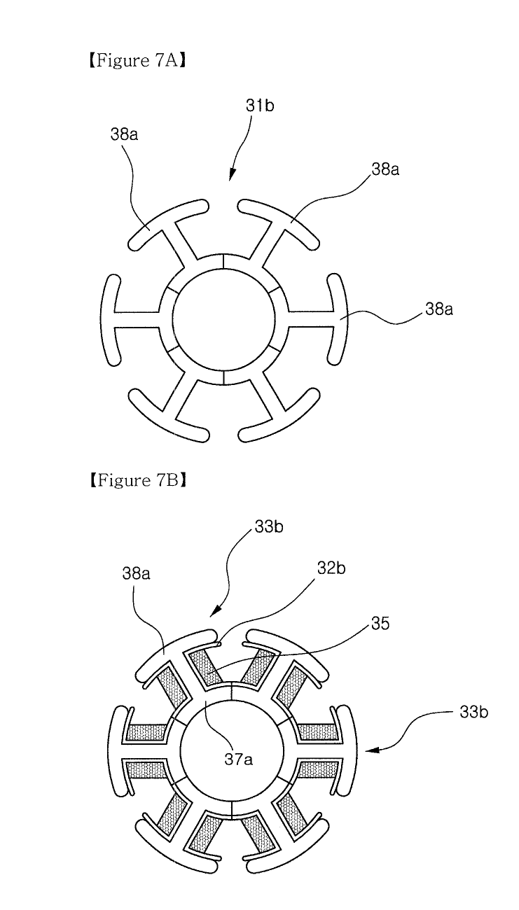

FIGS. 7A and 7B are a cross-sectional view to explain a division type core and a division type core assembly according to an embodiment of the present invention, respectively.

Referring to FIGS. 7A and 7B, in the case of the division type cores 31b according to the present invention, a number of the division type cores of a substantial ‘T’ or ‘I’ form on the whole, for example, six division type cores are combined to form a stator 30.

Each division type core 31b divides the integral type core 31a that is illustrated in FIG. 6A equally so as to include ‘T’ or ‘I’ type teeth 38a.

A coil 35 is wound around each division type core 31b, at a state where the bobbins 32b of an insulation material are combined by an insert molding method to thereby form a division type core assembly 33b. In the case that the coil 35 is wound using the division type cores 31b, the coil can be wound using an inexpensive general-purpose winding machine to accordingly enhance a productivity in comparison with the conventional art of winding the coil using the integral type cores.

Thereafter, for example, the lateral surfaces of the inner circumferential portions 37a of six division type core assemblies 33b, that is, those of the inner circumferential portions 37a of the neighboring division type core assemblies 33b, are welded and bonded. A bushing is integrally formed so that bearing accommodation grooves are provided to thereby form the stator 30.

Meanwhile, when the integral type core assemblies 33a and the division type core assemblies 33b are molded by an insert molding method, bearing accommodation grooves are molded and a fixing hook(not shown) which can fixedly combine the stator 30 to the control PCB 60 is integrally injection-molded. Thus, since the stator 30 can be fixed to the control PCB 60 using the fixing hook, an assembly productivity of the BLDC motors 1 can be enhanced.

Meanwhile, in order to match concentricity of the first and second bearings 81 and 82, it is required that the bearing accommodation grooves formed in the first and second positions should be disposed in a set position, respectively. However, when the bushing 36a of the stator 30 is formed by an insert molding, precision of a mold is required. Accordingly, it is difficult to fabricate a bearing accommodation groove so that a tolerance of an installation position of the bearing accommodation groove into which the first bearing 81 is inserted is 1/100 or less. Thus, in order to use an inexpensive mold instead of an expensive precise mold, it is preferable that a tolerance should be larger than 1/100, for example.

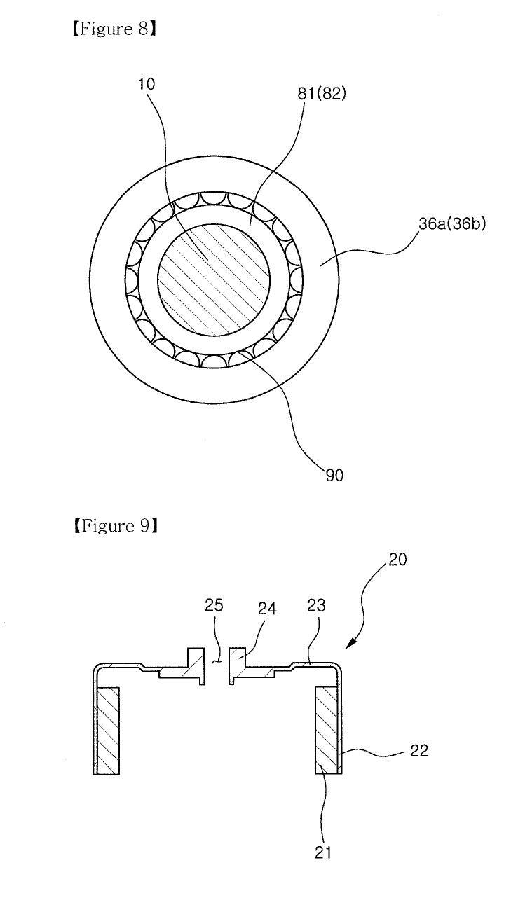

For this, when the bushing 36a of the stator 30 is formed in the present invention, a number of semicircular protrusions 90 have been formed in the inner circumferential portion of the bearing accommodation groove as shown in FIG. 8. As described above, if a number of protrusions 90 are formed in the outer lateral surface of the bearing accommodation groove, and a bearing housing is inserted in the inner circumferential portion of the bearing accommodation groove, so that a bearing is installed, it is possible to reduce a tolerance of a mold.

In addition, when injection-molding the PCB cover 61 in which the second bearing 82 is located, it is preferable that a required tolerance should be satisfied by forming the protrusions 90 in the outer lateral surface of the bearing accommodation groove which is provided at the central portion of the bearing housing. As a result, it is possible to design a tolerance of a mold to be larger than 1/100, to thus reduce a manufacturing cost.

FIG. 9 is a cross-sectional view to explain a rotor for a BLDC motor according to this invention.

Referring to FIG. 9, a rotor 20 includes: a central frame 23 having a central space 25 through which the rotational shaft 10 is combined; an annular yoke frame 22 which is bent and extended from the central frame 23 and which forms an annular shape on the whole; magnets 21 that are adhered to the inner circumferential surface of the yoke frame 22 and fixedly supports the rotational shaft 10 which is combined through the central space 25.

In this case, it is desirable that the yoke frame 22 is formed of a metallic material that can form a magnetic path.

In addition, a number of throughholes are provided in the central frame 23 in order to cool heat generated by an operation of the BLDC motor 1 in an air cooling method. Accordingly, a flow of air which cools heat from the stator 30 by rotation of the rotor 10 can be induced.

Meanwhile, the magnet 21 of the rotor 20 may be an annular magnetic substance which is adhered to the inner side of the yoke frame 22 in which N-pole and S-pole magnets are alternately divisively magnetized. Otherwise, the magnet 21 of the rotor 20 may be a division type magnet.

In addition, the rotor bushing 24 that makes the rotor 20 fixedly supported to the rotational shaft 10 is separately fabricated and then may be combined with the central frame 23 by an insert molding method.

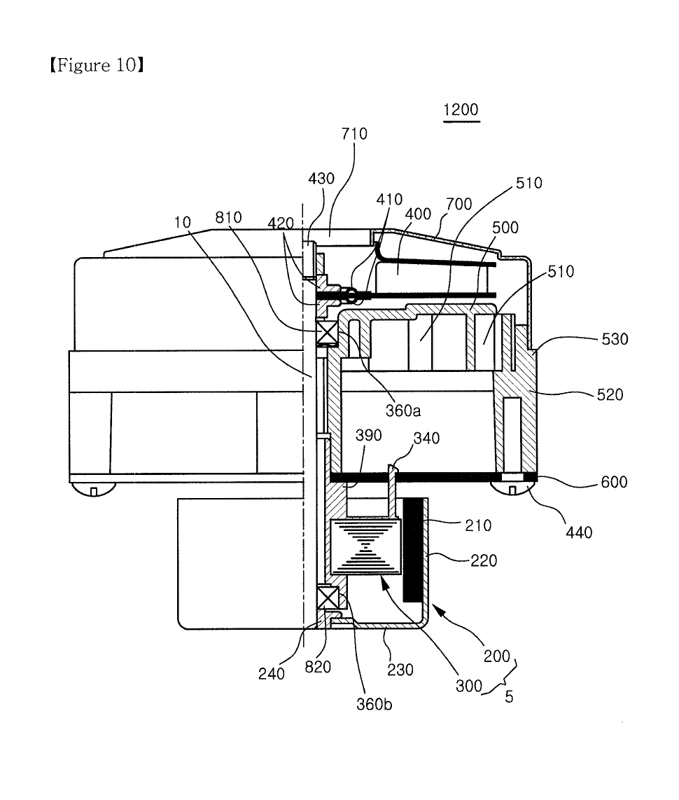

FIG. 10 is a partially cut cross-sectional view to explain a vacuum inhalation apparatus for a robot cleaner according to a second embodiment of this invention.

The vacuum inhalation apparatus 120 according to the first embodiment of the present invention as shown in FIGS. 4A to 4C, is implemented into an internal type that the BLDC motor 1 is located in the inside of fan guide 50, in which size of the vacuum inhalation apparatus 120 is designed to be compact. A vacuum inhalation apparatus 1200 according to the second embodiment of the present invention as shown in FIG. 10, is implemented into an external type that a BLDC motor 5 is located in an outer space of a fan guide 500. According to the second embodiment of the present invention, the BLDC motor 5 is separately manufactured and then is combined in the vacuum inhalation apparatus 1200, to thereby improve an assembly productivity.

Therefore, the vacuum inhalation apparatus 1200 according to the second embodiment of the present invention illustrated in FIG. 10 may not include a PCB cover. A stator 300 is combined with the lower portion of a control PCB 600 through a hook 340. In addition, the stator 300 is integrally molded with a stator holder 390 in which a rotational shaft 10 is combined, to then be fixedly supported thereto.

A second bearing 820 can be inserted into and incorporated in the lower portion of the stator holder 390. In addition, a bearing accommodation groove 360b in the inner circumferential surface of which protrusions 90 (see FIG. 8) are formed references is formed in page next week is provided in the lower portion of the stator holder 390.

Also, a first bearing 810 that supports the rotational shaft 10 is inserted into and incorporated at the central portion of a fan guide 500. In addition, a bearing accommodation groove 360a including protrusions 90 is formed is provided at the central portion of a fan guide 500.

Meanwhile, fan connecting rods 520 of the fan guide 500 are fixed by a clamp bolt 440 which is combined through a fixing hole that is provided on the control PCB 600, to thereby fixedly support the fan guide 500. Guide grooves 510 induce a flow of inhaled air.

Also, the stator 300 is positioned so that an air gap between the outer circumferential surface of the stator 300 and the inner circumferential surface of the rotor 200 can be maintained, and is hook combined on the control PCB 600. The rotor 200 is fixedly combined with the rotational shaft 10 through the rotor bushing 240 at the central portion of the central frame 230.

The control PCB 600 fixedly supports the stator 300 to be assembled and applies a voltage charged in a battery (not shown) to the BLDC motor 5 as a drive voltage.

In the second embodiment, the BLDC motor 5 includes the outer type rotor 200 and the stator 300 which is the same as the first embodiment. In FIG. 10, a reference numeral 210 denotes a magnet and a reference numeral 220 denotes a yoke frame.

Therefore, the rotational shaft 10 is combined with the central frame 230 of the rotor 200. Accordingly, the rotational shaft 10 is rotated since the rotor 200 rotates at high speed. As a result, an impeller 400 is rotated to thereby inhale air.

Moreover, in the upper portion of the fan guide 500 is positioned the impeller 400 which is closely combined with the rotational shaft 10 by a pair of impeller bushings 420 and a pair of impeller washers 410.

The fan guide 500 includes a number of spiral guide grooves 510 that guides inhaled air in the outer circumferential portion of the fan guide 500, and is bolt-coupled through a fixing hole which is provided in the control PCB 600, by a number of fan connecting rods 520, for example, four fan connecting rods 520.

The impeller 400 includes a number of guide vanes which are spirally arranged like the first embodiment of the present invention therein. The central portion of the lower plate of the impeller 400 is fixedly combined with the rotational shaft 10 by a pair of the impeller washers 410 and a pair of the impeller bushings 420.

Here, the lower plate of the impeller 400 is compressively fixed to a pair of the impeller washers 410 and a pair of the impeller bushings 420, by tightening a stop nut 430 which is screw-combined in the upper portion of the rotational shaft 10, and then is supported to the housing of a bearing 810. Therefore, a coherence force between the rotational shaft 10 and the impeller 400 becomes further strong, and thus the rotor 200 can rotate without sliding of the impeller 400 at the time of rotation of the rotor 200.

In addition, a cover 700 which protects the inner composition of the vacuum inhalation apparatus 1200 and forms external appearance to simultaneously form an air passage route is combined in the upper portion of the impeller 400. The cylindrical lower portion of the cover 700 is fixed to a coupling protrusion 530 which is provided on the outer circumference of the fan guide 500, to then be fixed.

Moreover, the rotational shaft 10 is supported to first and second bearings 810 and 820 which are located in first and second positions, respectively.

The respective first and second bearings 810 and 820 are inserted into and incorporated in a pair of bearing accommodation grooves 360a and 360b which are provided in the fan guide 500 and the stator holder 390. The bearing accommodation grooves 360a and 360b can be molded when the fan guide 400 and the stator holder 390 are formed.

Therefore, if a drive voltage is applied to the BLDC motor 5 and thus the impeller 400 is rotated by the rotational force which is generated according to rotation of the rotor 200, air existing in the inside of the impeller 400 is discharged into the lower side, that is, into the inside of the motor 5, along the guide grooves 510 of the fan guide 500, to thereby generate a strong negative pressure, by action of a number of guide vanes that are spirally arranged in the inside of the impeller 400.

If the strong negative pressure occurs, the external air is introduced through an inlet 710 which is provided at the center of the cover 700, and thus moves along the guide grooves 510 of the fan guide 500 through the impeller 400. The air that is inhaled into the motor 5 is discharged through a discharge space between the fan connecting rods 520 of the fan guide 500, to thereby generate an air flow.

In the second embodiment of the present invention, since the structures of the cover 700, the impeller 400, and the fan guide 500 are substantially same as those of the first embodiment of the present invention, the functional effects of the second embodiment of the present invention equal those of the first embodiment of the present invention.

However, since the BLDC motor 5 is located at the lower portion of the control PCB 600 in the vacuum inhalation apparatus 1200 according to the second embodiment of the present invention, the BLDC motor 5 is separately manufactured and then is combined in the vacuum inhalation apparatus 1200, to thereby improve an assembly productivity.

In addition, as stated above, if the BLDC motor 5 that generates an inhalation force is applied in the vacuum inhalation apparatus 1200, an inhalation efficiency can be improved, and thus electric power consumption reduces according improvement of the inhalation efficiency. As a result, an amount of heat to be cooled is reduced. Thus, although a separate heat radiator (for example, heat radiation fins or heat radiation housings) is not formed as a thermal conductor, the generated heat does not influence upon a power drive element greatly.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

### INDUSTRIAL APPLICABILITY

As described above, in the case of a vacuum inhalation apparatus according to the present invention, the rotational force of a rotor is effectively transferred to an impeller to thus pass through a curved passage route whose path is short and frictional resistance is small. Accordingly, accelerated airflow cools the inside of a motor. As a result, an inhalation efficiency increases more greatly than that of the conventional art, and an electric power consumption becomes small. Thus, an amount of heat generated from a power drive element decreases, and thus the inside of the motor can be cooled without having a special heat radiator.

In addition, the vacuum inhalation apparatus according to the present invention need not employ an aluminium heat radiator whose volume is large in order to cool conventional power drive elements. Accordingly, it is possible to design a drive motor as an internal type where the drive motor is located in an internal space between a fan guide and a control PCB. Thus, the whole length of the drive motor can be implemented in small size. As a result, the drive motor can be disposed in a vertical style in a cleaner, to thereby make the cleaner in a slim and compact style.

Therefore, the present invention can be applied to a slim type vacuum inhalation apparatus and a wireless type robot cleaner using the same in which an internal battery is used as an electric power source.

1. A vacuum inhalation apparatus comprising:
a brushless direct-current (BLDC) motor comprising a rotor and a stator, for generating a rotational force;
a rotational shaft which is fixedly combined at the center of the rotor through a rotor bushing so as to rotate;
an impeller which is located on the upper portion of the rotor and whose lower plate is fixedly coupled at one side of the rotational shaft to thus generate an inhalation force via a first intake hole which is located at the center of the upper plate of the impeller when the rotational shaft rotates;
a fan guide which is disposed between the impeller and the BLDC motor, in which a number of spiral guide grooves which guide a flow of air which is inhaled by the inhalation force generated by the impeller are formed in the outer circumferential portion of the fan guide and a number of fan connecting rods are extended in the outer circumferential portion of the lower end of the fan guide so as to surround the BLDC motor;
a control printed circuit board (PCB) in which the stator is fixed, and which applies a drive voltage for the BLDC motor;
a PCB cover that fixedly supports the number of the fan connecting rods of the fan guide, and protects the lower portion of the control PCB; and
a cover in which a second inhalation hole which is located at the center of the cover is extended to the first inhalation hole of the impeller, and the outer circumferential portion of the cover surrounds the impeller and the fan guide, and which is extended to form an air passage route between the number of guide grooves and the inner circumferential portion of the cover and is combined in the outer circumferential portion of the fan guide,
wherein external air which is introduced from the guide grooves of the fan guide into the inside of the BLDC motor via the air passage route is discharged into the space which is formed between the number of the fan connecting rods.

2. The vacuum inhalation apparatus according to claim 1, further comprising:
a lower impeller washer which contacts between the rotor bushing and the lower-center portion of a lower plate of the impeller over a wide contact area;
an upper impeller washer whose lower surface contacts the upper-center portion of the lower plate of the impeller over a wide contact area;
an impeller bushing which is located at the upper portion of the upper impeller washer and has a relatively smaller contact area than that of the upper impeller washer, and with a hole at the center of which the rotational shaft is combined; and
a fixing nut which is screw-combined with the upper portion of the rotational shaft and makes the impeller bushing and the upper and lower impeller washers closely adhered to the rotor bushing, to thus make the impeller fixed to the rotational shaft.

3. The vacuum inhalation apparatus according to claim 1, further comprising:
a first bearing that is placed in the bushing formed in the inner circumferential portion of the stator and that rotatably supports one end of the rotational shaft; and
a second bearing which is placed at the central portion of the cover, to thus rotatably supports the other end of the rotational shaft,
wherein a number of protrusions are formed in bearing accommodation grooves where the first and second bearings of the bushing and the central portion of the cover are installed.

4. The vacuum inhalation apparatus according to claim 1, wherein the stator comprises:
a number of division type cores;
a number of bobbins which are formed of an insulation material and are combined with the outer circumference of the division type cores, respectively;
a coil that is wound in a space that is provided by the bobbins; and
a stator holder including a hook and a first bearing accommodation groove which are combined on the control PCB and which is integrated by an insert molding method using thermosetting resin to form a number of division type core assemblies where the coil is wound around the bobbins of the division type core in an annular form,
wherein a number of protrusions are formed in the inner circumferential surface of the first bearing accommodation groove, in order to minimize a tolerance of the built-in first bearing.

5. The vacuum inhalation apparatus according to claim 1, wherein the BLDC motor comprises:
a rotor where a number of N-pole and S-pole magnets are alternately arranged in the inner circumferential surface of a yoke frame which is bent and extended from a central frame;
a stator which is arranged in the inside of the rotor and around which the coil is individually wound at a state where the bobbins are combined with the number of division type cores, respectively, to thereby be integrally formed via the stator holder by an insert molding method using thermosetting resin;
a rotational shaft which is combined in the central portion of the rotor through the rotor bushing so as to rotate; and
a control printed circuit board (PCB) which is hook-combined via a hook which is integrally formed with the stator holder, to thereby fix the stator and to apply a drive voltage for the BLDC motor.

6. The vacuum inhalation apparatus according to claim 1, wherein the vacuum inhalation apparatus is applied in a robot cleaner.

7. A vacuum inhalation apparatus comprising:
a brushless direct-current (BLDC) motor comprising a rotor and a stator, for generating a rotational force;
a rotational shaft which is fixedly combined at the center of the rotor through a rotor bushing so as to rotate;
a control printed circuit board (PCB) to the bottom of which the stator is fixed, and which applies a drive voltage for the BLDC motor;
an impeller whose lower plate is fixedly coupled at one side of the rotational shaft to thus generate an inhalation force via a first intake hole which is located at the center of the upper plate of the impeller when the rotational shaft rotates;
a fan guide which is disposed between the impeller and the control PCB, in which a number of spiral guide grooves which guide a flow of air which is inhaled by the inhalation force generated by the impeller toward the upper side of the control PCB are formed in the outer circumferential portion of the fan guide and a number of fan connecting rods which are located at the outer circumferential portion of the lower end of the fan guide are fixedly supported to the outer circumferential portion of the control PCB; and
a cover in which a second inhalation hole which is located at the center of the cover is extended to the first inhalation hole of the impeller, and the outer circumferential portion of the cover surrounds the impeller and the fan guide, and which is extended to form an air passage route between the number of guide grooves and the inner circumferential portion of the cover and is combined in the outer circumferential portion of the fan guide,
wherein external air which is introduced from the guide grooves of the fan guide into the upper side of the control PCB via the air passage route is discharged into the space which is formed between the number of the fan connecting rods.

8. The vacuum inhalation apparatus according to claim 7, further comprising:
a first bearing that is placed at the center of the fan guide, and that rotatably supports one end of the rotational shaft; and
a second bearing that is placed in the bushing formed in the inner circumferential portion of the stator, to thus rotatably supports the other end of the rotational shaft,
wherein a number of protrusions are formed in bearing accommodation grooves where the first and second bearings are installed.

9. The vacuum inhalation apparatus according to claim 8, further comprising:
a lower impeller bushing which is located at the upper portion of the first bearing and with a hole at the center of which the rotational shaft is combined;
a lower impeller washer which has a relatively larger contact area than that of the lower impeller bushing, and contacts the lower-center portion of the lower plate of the impeller;
an upper impeller washer whose lower surface contacts the upper-center portion of the lower plate of the impeller over a wide contact area;
an upper impeller bushing which has a relatively smaller contact area than that of the upper impeller washer, and with a hole at the center of which the rotational shaft is combined; and
a fixing nut which is screw-combined with the upper portion of the rotational shaft and makes the upper and lower impeller bushings and the upper and lower impeller washers closely adhered to the first bearing, to thus make the impeller fixed to the rotational shaft.

10. The vacuum inhalation apparatus according to claim 7, wherein the stator comprises:
a number of division type cores;
a number of bobbins which are formed of an insulation material and are combined with the outer circumference of the division type cores, respectively;
a coil that is wound in a space that is provided by the bobbins; and
a stator holder including a hook and a first bearing accommodation groove which are combined on the control PCB and which is integrated by an insert molding method using thermosetting resin to form a number of division type core assemblies where the coil is wound around the bobbins of the division type core in an annular form,
wherein a number of protrusions are formed in the inner circumferential surface of the first bearing accommodation groove, in order to minimize a tolerance of the built-in first bearing.

11. The vacuum inhalation apparatus according to claim 7, wherein the BLDC motor comprises:
a rotor where a number of N-pole and S-pole magnets are alternately arranged in the inner circumferential surface of a yoke frame which is bent and extended from a central frame;
a stator which is arranged in the inside of the rotor and around which the coil is individually wound at a state where the bobbins are combined with the number of division type cores, respectively, to thereby be integrally formed via the stator holder by an insert molding method using thermosetting resin;
a rotational shaft which is combined in the central portion of the rotor through the rotor bushing so as to rotate; and
a control printed circuit board (PCB) which is hook-combined via a hook which is integrally formed with the stator holder, to thereby fix the stator and to thereby apply a drive voltage for the BLDC motor.

12. The vacuum inhalation apparatus according to claim 7, wherein the vacuum inhalation apparatus is applied in a robot cleaner.

13. A robot cleaner comprising:
a main body;
a number of wheels which are located at the lower portion of the main body, and which make the main body move to a predetermined direction;
a dust collector which collects foreign matters in air inhaled via an inhalation nozzle;
a vacuum inhalation apparatus which generates an inhalation force that inhales air through the inhalation nozzle; and
a battery that offers a drive power to the vacuum inhalation apparatus,
wherein the vacuum inhalation apparatus comprises:
a brushless direct-current (BLDC) motor comprising a rotor and a stator, for generating a rotational force;
a rotational shaft which is fixedly combined at the center of the rotor through a rotor bushing so as to rotate;
an impeller which is located on the upper portion of the rotor and whose lower plate is fixedly coupled at one side of the rotational shaft to thus generate an inhalation force via a first intake hole which is located at the center of the upper plate of the impeller when the rotational shaft rotates;
a fan guide which is disposed between the impeller and the BLDC motor, in which a number of spiral guide grooves which guide a flow of air which is inhaled by the inhalation force generated by the impeller are formed in the outer circumferential portion of the fan guide and a number of fan connecting rods are extended in the outer circumferential portion of the lower end of the fan guide so as to surround the BLDC motor;
a control printed circuit board (PCB) in which the stator is fixed, and which applies a drive voltage for the BLDC motor;
a PCB cover that fixedly supports free ends of the number of the fan connecting rods of the fan guide, and protects the lower portion of the control PCB; and
a cover in which a second inhalation hole which is located at the center of the cover is extended to the first inhalation hole of the impeller, and the outer circumferential portion of the cover surrounds the impeller and the fan guide, and which is extended to form an air passage route between the number of guide grooves and the inner circumferential portion of the cover and is combined in the outer circumferential portion of the fan guide.

14. The robot cleaner according to claim 13, wherein the stator comprises a stator holder which is integrally formed by assembling a number of division type cores around which the coil is individually wound in an annular form, using thermosetting resin.

15. The robot cleaner according to claim 14, wherein the division type cores are implemented in an ‘I’ type or a ‘T’ type.

16. The robot cleaner according to claim 13, further comprising:
a lower impeller washer which contacts between the rotor bushing and the lower-center portion of a lower plate of the impeller over a wide contact area;
an upper impeller washer whose lower surface contacts the upper-center portion of the lower plate of the impeller over a wide contact area;
an impeller bushing which is located at the upper portion of the upper impeller washer and has a relatively smaller contact area than that of the upper impeller washer, and with a hole at the center of which the rotational shaft is combined;
a fixing nut which is screw-combined with the upper portion of the rotational shaft and makes the impeller bushing and the upper and lower impeller washers closely adhered to the rotor bushing, to thus make the impeller fixed to the rotational shaft.

17. The robot cleaner according to claim 13, further comprising:
a first bearing that is placed in the bushing formed in the inner circumferential portion of the stator and that rotatably supports one end of the rotational shaft; and
a second bearing which is placed at the central portion of the cover, to thus rotatably supports the other end of the rotational shaft,
wherein a number of protrusions are formed in bearing accommodation grooves where the first and second bearings of the bushing and the central portion of the cover are installed.
